(19) United States
(12) Patent Application Publication
(10) Pub. No.: US 2011/0295875 A1
(43) Pub. Date: Dec. 1, 2011

(54) LOCATION-AWARE QUERY BASED EVENT RETRIEVAL AND ALERTING

(75) Inventors: ANTOINE EL DAHER, Redmond, WA (US); FARAH M. ALI, Kirkland, WA (US); SALLY SALAS, Issaquah, WA (US); JAMES CLARK, Duvall, WA (US)

(73) Assignee: MICROSOFT CORPORATION, REDMOND, WA (US)

(21) Appl. No.: 12/788,808

(22) Filed: May 27, 2010

(51) Int. Cl. G06F 17/30

(52) U.S. Cl. 707/769; 707/E17.014

(57) ABSTRACT

Hybrid search results are provided based on analyzing a web-query and a location. Hybrid search results may include a web-search result and an event-search result. The event-search result may be identified based on identifying a location associated with the search engine user and the web-query. The event-search result may include event details, such as time, location and descriptive information. Additionally, an event-alert link may be provided. An event-alert link may allow a user to receive updates related to an event.

### BACKGROUND

Online searching has become a significant aspect of computing environments, as it presents a powerful way for users to find information. For instance, online searching is often used by users to locate web pages that contain information about people, products and services. Location information associated with the user may sometimes be identified and used by a web search engine to provide more useful results to that user. For example, a user's location may be taken into account to provide search results associated with stores near that user. A user may also use online searching to find events. For instance, the user may wish to search an event search engine for rock concerts.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing hybrid search-results for presentation in web search environments. Hybrid search-results are generated by augmenting a web-search result with an event-search result. The web-search result is associated with a web page, and is identified based on a web-query received from a user. The event-search result is associated with an event and a location, and is identified based on a web-query received from the user and a location associated with the user. The hybrid search-results may be provided to the user for display. The event-search result may include certain details related to the event, such as the name of the event, the time of the event, the location of the event, etc. The user may click on the event-search result to see additional details associated with the event. The user may then purchase tickets for the event, and revenue from the purchase of tickets may be split between the search engine, which provided the link to the event, and the ticket seller. The user may be provided with the ability to request an alert should an event at a specific time and location be created at a later time. This alert feature allows the user to be notified of a future event of interest to the user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the present invention may be employed;

FIG. 3A is a screen display showing an embodiment of the present invention;

FIG. 3B is another screen display showing an embodiment of the present invention;

FIG. 4 is a flow diagram that illustrates a method for providing hybrid search-results to a user;

FIG. 5 is a flow diagram that illustrates another method for providing hybrid search-results to a user; and

FIG. 6 is a block diagram of an exemplary hybrid search result delivery system in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As previously indicated, embodiments of the present invention are generally directed to providing hybrid search-results to a user. As used herein, the term “web-query” generally refers to a query directed to search engine indexing web pages originating on third-party websites. Additionally, as used herein, the term “web-search result” means a search result associated with a web page from a third-party website. The term “event” refers to an occurrence associated with a time and location. The term “event-search result” refers to a search result associated with an event. The term “event category” refers to a type of event. An event category could include, for example, a “concert”, “sporting event”, “parade”, “basketball game”, “political event”, or “Britney Spears concert”. The term “event-alert link” means a link providing an option to notify the user at a later time of an event that may be of interest.

In accordance with embodiments of the present invention, upon receiving a web-query, it may make sense to provide hybrid search-results to the user for display. Generally, a web-query will result in numerous web-search results being identified. Additionally, certain web-queries will lead to the identification of events that may be relevant to the user. For example, a web-query directed to a particular musical group may result in the identification of concerts associated with that musical group. It may be determined that a particular concert associated with this musical group is scheduled to occur near a location associated with the user. A search result associated with this particular event may thus be provided to the user along with a portion of the web-search results.

The identification of events may be based in part upon a location associated with the user. For example, the IP address of the computer a user utilized to transmit a web-query may be analyzed to determine a probable location associated with the user. In another example, the user may be utilizing a device equipped to provide GPS coordinates to the search engine. In yet another example, a location may be determined by analyzing a profile associated with the user. In yet another example, a location may be determined by examining the web-query. Once a location associated with the user has been determined, an event database may be queried. In some embodiments, the event database will return one or more events associated with the location and the web-query, and one or more of these event-search results associated with these events may be provided to the user for display. In other embodiments, the event database may return no events associated with the location and the web-query. In response, an alert interface may be provided to the user such that the user can be sent a notification at a later time regarding an event related to the web-query and location.

In some embodiments, the event database may be populated directly through the utilization of an API. For example, a concert promoter may directly insert an event into the database by accessing a publicly exposed API interface. Later, upon receiving a web-query related to this event, this event may be retrieved and an event-search result associated with this event may be provided to a user. In other embodiments, the event database may be populated by intelligently crawling web pages containing event information. The identification of event information may be based on a number of factors, such as the presence of location information, time information, and contextual cues (i.e., a page title of “Upcoming Seattle Concerts”).

Accordingly, in one aspect, an embodiment of the present invention is directed to one or more computer-readable media storing computer-useable instructions that, when used by one or more computing devices, cause the one or more computing devices to perform a method. The method includes receiving a web-query from a user. The method also includes identifying a location associated with the user. The method further includes identifying an event-search result based on the location and the web-query. The method still further includes identifying a web-search result based on the web-query. The method also includes providing the web-search result and the event-search result to the user for display.

Another embodiment the present invention is directed to one or more computer-readable media storing computer-useable instructions that, when used by one or more computing devices, cause the one or more computing devices to perform a method. The method includes receiving a web-query from a user. The method also includes identifying a location associated with the user. The method further includes determining that there is no event-search result associated with the location and the web-query. The method also includes identifying a web-search result based on the web-query. The method still further includes providing the web-search result and an event-alert link to the user for display.

A further embodiment of the present invention is directed to one or more computer-readable media storing computer-useable instructions that, when used by one or more computing devices, cause the one or more computing devices to provide hybrid search-results. The hybrid search-results include a web-search result. The web-search result is associated with a web page. The hybrid search-results also include an event-search result. The event-search result is associated with a time and a location.

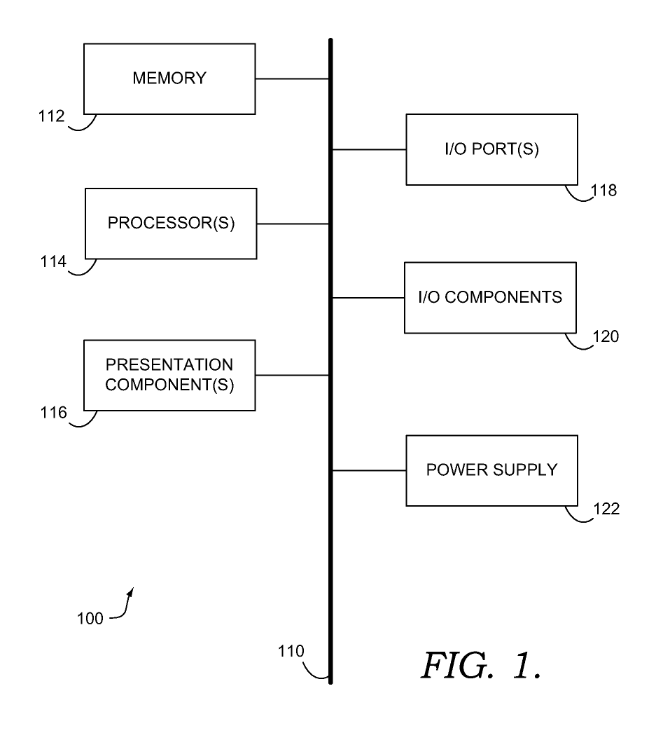

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other hand-held device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above should also be included within the scope of computer-readable media.

Memory 112 includes computer-storage media in the form of volatile and/or non-volatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to an end user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

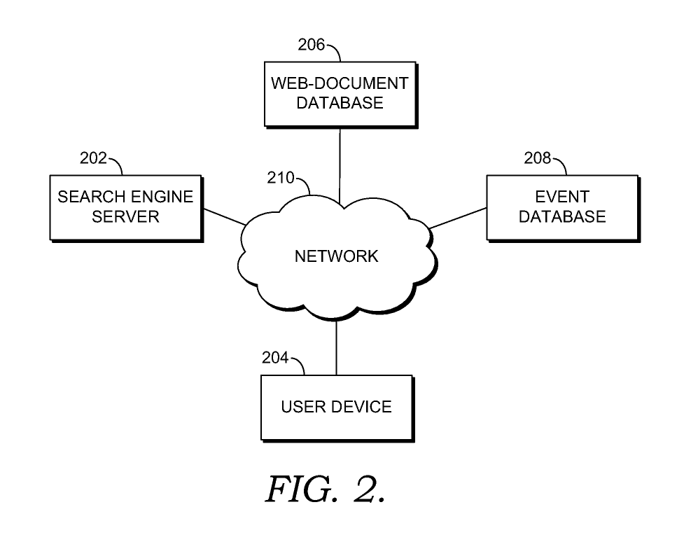

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 200 may include a search engine server 202, a user device 204, web-document database 206, and event database 208. Each of the search engine server 202, user device 204, web-document database 206, and event database 208 may include any type of computing device, such as computing device 100 described with reference to FIG. 1, for example. The components communicate with each other via a network 210, which may include, without limitation, one or more local area networks (LANs) and/or wide area networks (WANs). Such networking environments are commonplace in offices, enterprise-wide computer networks, intranets, and the Internet. It should be understood that any number of search engine servers, user devices, web-document databases, event databases, and networks may be employed within the system 200 within the scope of the present invention. Each may comprise a single device or multiple devices in a distributed environment. Additionally, other components not shown may also be included within the system 200.

The system 200 illustrates an Internet environment in accordance with one embodiment of the present invention. Generally, the search engine server 202 provides an interface for users with which to search over a number of Internet documents indexed by the web-document database 206. A user may employ an user device, such as the user device 204, to access the search engine server 202. The search engine server 202 may provide a search interface to the user with which to conduct an Internet search. The user device 204 may be a computer, a cellular phone, or any device capable of being connected to the system. The search engine server 202 may receive a web-query from the user device 204. Upon receiving the web-query, the search engine server 202 may query the web-document database 206 to compile a number of web-search results. The search engine server 202 may also query event database 208 to compile a number of event-search results. The search engine server 202 may then return the web-search results and event-search results to the user device 204.

For example, web-document database 206 may contain a number of results corresponding to the web-query “BB King”. In addition, event database 208 may contain a number of events corresponding to the web-query “BB King”, including a concert in Seattle, Wash. on January 15^{th}. User device 204 may be located in Seattle, Wash., and may connect to search engine server 202 over the network 210. Search engine server 202 may determine that user device 204 is located in Seattle, Wash., for instance, by analyzing the IP address associated with user device 204. User device 204 may submit the web-query “BB King” to the search engine server 202. Search engine server 202 may query web-document database 206 to compile a number of web-search results corresponding to this web-query. Search engine server 202 may also determine that the web-query “BB King” may have related events. Search engine server 202 may query event database 208 with the web-query and the location of Seattle, Wash. to retrieve an event-search result associated with the BB King concert in Seattle, Wash. on January 15^{th}. This event-search result, along with web-search results, may be provided to user device 204.

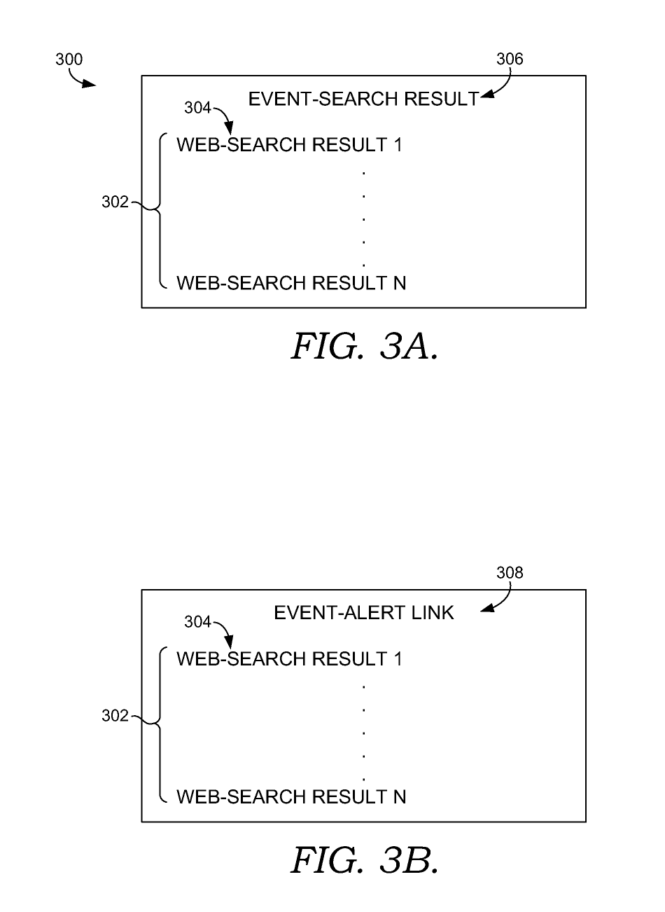

Referring now to FIG. 3A, a diagram is provided illustrating an exemplary screen display showing an embodiment of the present invention. The screen display includes web-search results 302, including web-search result 304, and event-search result 306. For example, a user may send a web-query to search engine server 202. Search engine server 202 may determine a location associated with the user based on, for instance, GPS coordinates received from the user device. Search engine server 202 may compile web-search results 302 and event-search result 306 based on querying web-document database 206 with the web-query and event database 208 with the web-query received and the location. The user may be presented with a screen resembling the screen depicted in FIG. 3A. The user can view the web-search results 302 and event-search result 306. Event-search result 306 may provide notice to the user of the date and location of the event. The user may be interested in event-search result 306, and may wish to be provided with additional information relating thereto. The user may, for example, click event-search result 306 to be provided with additional details related to the event (such as the ticket price and starting time of the event, for example). The user may also be provided with the opportunity to purchase tickets for the event.

Referring to FIG. 3B, another diagram is provided illustrating an exemplary screen display showing another embodiment of the present invention. The screen display includes web-search results 302, including web-search result 304, and event-alert link 308. For example, a user may send a web-query to search engine server 202. Search engine server 202 may determine a location associated with the user, for instance, based on the IP address of the user device. Search engine server 202 may compile web-search results 302 by querying web-document database 206. Search engine server 202 may also query event database 208 and determine that, although there are events related to the web-query, there are no events related to the web-query and location. Accordingly, the user may be presented with a screen resembling the screen depicted in FIG. 3B. The user may view web-search results 302 and event-alert link 308. Event-alert link 308 may inform the user that, while there are currently no events related to the web-query scheduled to occur at that location, the user may click the alert link and be alerted should an event related to the web-query and location be added to the event database. The user may wish to be so alerted, and so may click event-alert link 308. Upon an event relating to the web-query and location being added to the event database, an email may be sent to the user informing of the newly added event.

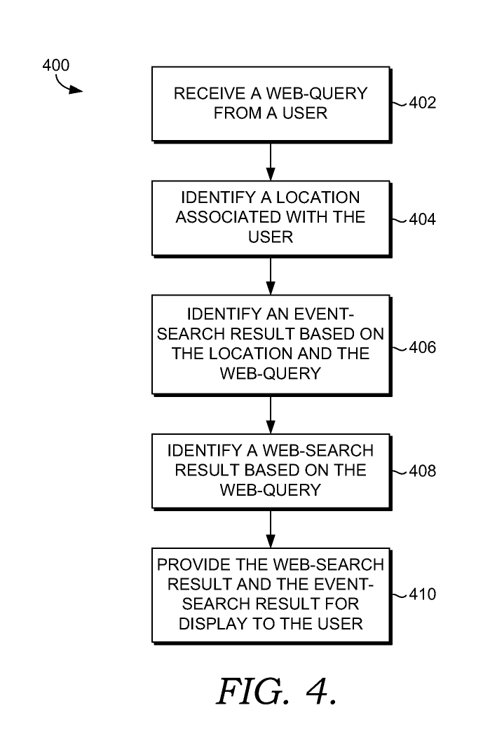

Referring now to FIG. 4, a flow diagram is provided that illustrates a method 400 for providing hybrid search-results to a user. Initially, as shown at block 402, a web-query is received from a user. The user may be associated with a location. For example, the user may be using a laptop computer in a coffee shop in Seattle, Wash. As shown at block 404, a location associated with the user is identified. For example, the laptop computer may provide GPS coordinates to the search engine. In some instances, the user may be queried to determine whether or not GPS data may be collected and/or shared. Alternatively, the user's approximate location may be determined by analyzing the user's IP address. In still another alternative, a location may be determined by analyzing profile information associated with the user. Specifically, the user may have a stored profile indicating that the user currently lives in Redmond, Wash. In yet another alternative, a location may be determined from the context of the web-query (i.e., the web-query could be “BB King Portland”). Thus, it can be seen that the location associated with the user is not necessarily that user's current location. An event is identified based on the location and the web-query, as illustrated at block 406. A web-search result is also identified based on the web-query, as illustrated at block 408. The web-search result and the event are provided to the user for display, as illustrated at block 410.

For instance, a user may connect to a search engine using a mobile phone in Kansas City, Mo. The user may enter the web-query “Seahawks” into her mobile phone. At block 402, the web-query “Seahawks” is received. The user's mobile phone may submit GPS coordinates to the search engine, indicating that the user is currently in Kansas City, Mo. Utilizing these received GPS coordinates, Kansas City, Mo. is identified at block 404 as a location associated with the user. The search engine may determine that “Seahawks” is related to one or more events in an event database by querying the event database and determining that at least one result associated with “Seahawks” exists. The search engine may query the event database with the location and the web-query, “Seahawks”. A football game between the Seattle Seahawks and the Kansas City Chiefs on November 17^{th} may be identified at block 406. A web-search result associated with “www.seahawks.com” may be identified at block 408 by querying a web-document database. The event-search result associated with the November 17^{th} football game and the web-search result associated with “www.seahawks.com” may be provided to the user for display at block 410.

In another example, a user may connect to a search engine utilizing a laptop computer in New York City, N.Y. The user may connect to a search engine server, and the search engine server may acquire the user's IP address. The user may submit a web-query, “Bolero”, to a search engine server. The search engine server may receive the “Bolero” web-query at block 402. The search engine may identify a location associated with the user at block 404 by analyzing the acquired IP address to determine that the IP address is associated with a coffee shop in New York City, N.Y. At block 406, a event database may be queried with the web-query “Bolero” and the location “New York City, NY” to identify an event-search result associated with a event on March 2^{nd} at Carnegie Hall. At block 408, a web-search result associated with the Wikipedia web page for the orchestral piece by Ravel is identified by querying a web-document database. This web-search result along with the event-search result is provided to the user at block 410.

It should be noted that a location may be identified in a number of ways at block 404. For instance, the user may have created a profile indicating that she lives in Miami, Fla. The search engine may thus identify Miami, Fla. as a location associated with the user by examining this previously created user profile. Alternatively, a location may be identified by analyzing the content of the web-query. For example, the web-query may be “Bolero NYC”, in which case it may be determined that the “Bolero” segment of the web-query is associated with a “concert” event category, while it may be determined that the “NYC” segment of the web-query is associated with a location. Latitude and longitude coordinates associated with “NYC” may be identified, and an event-search result may be identified by querying an event database with the event “Bolero” and these latitude and longitude coordinates. For example, an event-search result may be identified as being associated with “Bolero” and sufficiently proximate to the identified location.

In some instances, there may be multiple locations subject to identification. These multiple locations may be analyzed, possibly along with other location-identifying indicia, to identify the most relevant location associated with the user. For example, a user profile may indicate that the user lives in New York City, N.Y., while GPS coordinates associated with the user may indicate that the user is currently in Phoenix, Ariz. These multiple associated locations may be analyzed, possibly along with other location-identifying indicia, to determine the most appropriate location to identify for providing hybrid search results. For example, an analysis of the user's history may indicate that it is probable that she has moved from New York City but has not updated her profile. In particular, an analysis of user history may indicate that the user performed search queries seeking New York City movers, and/or the user has not had GPS coordinates associated with New York City in several months. In another example, the user's precise GPS coordinates may indicate that the user is at an airport in Phoenix. This information, possibly along with other indicia (such as, for example, a search history indicating a layover in Phoenix), can be analyzed to determine the most appropriate location for providing hybrid search results.

In some embodiments, an event database may be utilized to identify event-search results. The event database may include a plurality of events. Each event may include, for example, a date, time, title, GPS coordinates, city, state, current attendees, descriptive information, etc. The event database may be populated through the utilization of an API. For example, a third party may wish to add an event corresponding to a Pearl Jam concert in Detroit, Mich. to the event database. The third party may provide the date, time, location and other descriptive details to the event API, and an event may be created in the event database with this information. Subsequently, a “Pearl Jam” web-query may be received from a user, and it may be determined that the user is near Detroit, Mich. The event database may be queried with this web-query and location, and the event may be returned and subsequently an associated event-search result may be provided to the user. Events may be identified based on their indicated time of occurrence as well. For example, an event that has already occurred may exist in the database, but may not be relevant for the user because it has already occurred. Additionally, an event might be identified but not relevant to a user because its indicated time of occurrence is too far in the future. In yet another example, an event might not be identified as relevant to a user because it occurs at a future time where it is known that the user will not be in the identified location. For example, it may be determined that the user is planning a vacation for the 3rd week of March, so an event in the user's hometown for the 3rd week of March might not be of interest to that user.

It should be noted that, in some instances, a user may not be interested in a particular event-search result provided. In some embodiments, an event-alert link may be provided to the user. This event-alert link may provide a clickable link that allows the user to be alerted in the future should another event of possible interest be identified. For example, the user may have submitted the web-query “Tom Petty”. The location Nashville, Tenn. may be identified as associated with the user, based on, for instance, the GPS coordinates of the user. An event-search result associated with a Tom Petty concert in Memphis, Tenn. may be identified, and the web-search result associated with the home page for Tom Petty may be identified. This event-search result and web-search result may be provided to the user, along with an alert-event link.

The user, however, may be driving cross country and merely passing through Tennessee, and thus might not be interested in a Tom Petty concert in Memphis, Tenn. The user may therefore click the event-alert link, and an event-alert request may be received at a web server. The event-alert request may be associated with “Tom Petty”, and an event alert may be created and stored in a database. This event alert may be associated with the user and various information about the user. For example, there may be a token in a database associated with the user that may be linked or otherwise associated with the event alert. Subsequently, the user may be sitting at her residence in Bentonville, Ark., and a Tom Petty concert in Little Rock, Ark. may be added to the event database. Upon the addition of this event, the event alert may cause an notification of this event to be provided to the user. The event alert may, for example, be provided via an email sent to an email address associated with the user. This email may inform the user that Tom Petty is scheduled to play a concert near Bentonville, Ark., and provide a link to a website where tickets may be purchased. The link to the ticket-purchasing website may provide referral information such that the search engine operator may be optionally compensated should the user decide to purchase a ticket from a third-party website.

Additionally, it should be considered that the user may be notified of an event alert via other forms of communication, including SMS messages, phone calls, internet posts, etc. It should also be considered that an event alert may be associated with a variety of locations, including the user's home location, the user's location when requesting the event alert, a location provided by the user along with the event-alert request, the user's current location, etc. Events may also be associated with time zones. The location and time zones for events may be taken into account when identifying events. Further, it should be noted that an event-search result may provide an opportunity to purchase a ticket to the event associated with the event-search result.

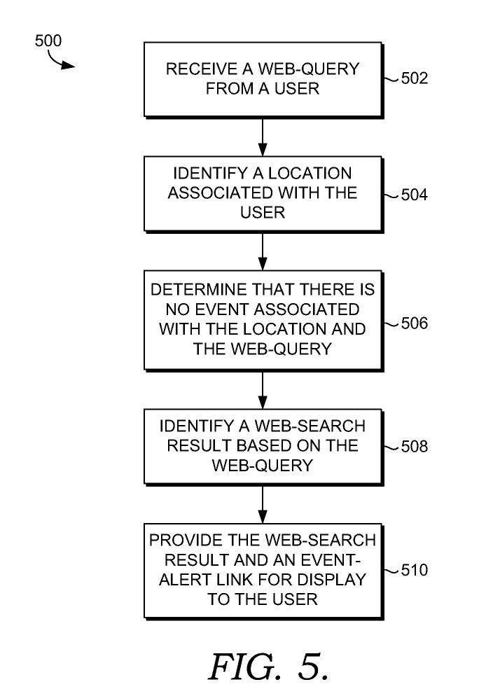

Turning now to FIG. 5, a flow diagram is provided that illustrates a method 500 for providing hybrid search-results to a user. A web-query is received from a user at block 502. The user may be associated with a location. For instance, there may exist a stored profile associated with the user that indicates a location. As shown at block 504, a location associated with the user is identified. This location may be identified by examining an associated user profile, or by determining the current location of the user by examining, for instance, the user's IP address. As illustrated at block 504, it is determined that there is no event associated with the location and the web-query. For instance, an event database may be queried to determine that there are no events associated with both the location and the web-query. As shown at block 508, a web-search result is identified based on the web-query. For example, a web-document database may be queried with the web-query to produce one or more web-search results associated with one or more web-documents. The web-search result and an event-alert link are provided, as shown at block 510.

For instance, a user may be utilizing a desktop computer at his office in Vancouver, Canada. The user may connect to a search engine server, and submit a web-query of “NCAA Tournament”. This web-query may be received from the user at block 502. The user's IP address may be analyzed, and approximate latitude and longitude coordinates near Vancouver, Canada may be identified at block 504. An event database may be queried with the latitude and longitude coordinates and the web-query “NCAA Tournament”, and it may be determined that there is no event associated with these elements at block 506. For instance, there may be no entry for “NCAA Tournament” near Vancouver, Canada in the event database, resulting in the determination that there is no event associated with the web-query and the location. At block 508, a web-search result associated with “ncaa.com” is identified by querying a web-document database with the web-query “NCAA Tournament”. It should be noted that, often, many web-documents associated with a web-query may be identified. At block 510, this web-search result and an event-alert link is provided to the user. The event-alert link may, for example, contain the text “Click Here to Receive Alerts About NCAA Tournament Games Near You”. The user may choose to click the event-alert link. The user may be prompted to enter his email address. An event alert associated with “NCAA Tournament” and “Vancouver, Canada” may be created in a database.

Alternatively, an event alert associated with “NCAA Tournament” and the dynamic current user location may be created in the database. In this instance, the event alert would be triggered whenever the user's current location coincides with an event associated with “NCAA Tournament”. For example, while there may be no event associated with the user's current location of Vancouver, Canada and “NCAA Tournament”, there may be an event associated with Dallas, Tex. and “NCAA Tournament”—for instance, a Sweet 16 game between Texas A&M and Michigan State. This user, upon receiving the web-search result and the event-alert link, might click the event-alert link and choose to associate his mobile phone with the event-alert. An event alert associated with the dynamic current user location of the user and “NCAA Tournament” may thus be created. Subsequently, the user might board a plane from Vancouver, Canada to Dallas, Tex. Upon arriving in Dallas, Tex., the user's mobile phone might connect to the internet and provide current GPS coordinates to a web server. The web server may determine that the mobile phone is associated with the event-alert, and further determine that the current location of the mobile phone and “NCAA Tournament” is associated with an event—namely, the Texas A&M and Michigan State basketball game in Dallas, Tex. Accordingly, an SMS message may be provided to the user, alerting him to the occurrence of this event near his current location associated with “NCAA Tournament”.

It should be noted that there are a number of ways in which a user may be notified via an event alert. For example, the user may decide to click an event-alert link, generating an event-alert request that may be received by a web server. The user may provide his email address to the web server. The web server may store a token associated with the event-alert request in a database. The token may also be associated with the web-query, the user's current location, the user's profile information, the user's mobile phone, the user's search history, etc. The database may be queried when a new event is added to an event database. A token associated with the user may be returned, and the user may be notified of the newly added event.

In some embodiments, it may be determined that a web-query is associated with an event. For instance, a web-query “New York Yankees” may be received. An event database may be queried, and it may return a number of events associated with “New York Yankees”. Thus, the web-query would be determined to be associated with an event. This determination could be useful in determining whether to provide an event-alert to the user. For instance, if the web-query were associated with an event, but not an event relevant to the user's current location, an event-alert link might be advantageously provided to the user. Specifically, the existence of at least one event associated with the web-query in the event database may indicate that the web-query is associated with an event category. Alternatively, a web-query “Boolean Algebra” may be received. An event database may be queried, and it may return no events associated with “Boolean Algebra”. This determination could be useful in determining to not provide an event-alert link to the user. Specifically, because there is no event associated with “Boolean Algebra” in the event database, it may be inferred that “Boolean Algebra” is not an event category. Thus, it might be advantageous to not provide an event-alert link to the user.

It should be noted that there are a number of ways in which to determine whether to provide an event-alert link to the user. For instance, the probability that an event will be added to the database in the future corresponding to the web-query and location may be determined. This probability may be determined, for example, by calculating the number of times an event associated with the web-query and location has been added to the database in the past. If, for example, an event relating to the web-query and location has been added, on average, twice per year for the past four years, it could be determined that there is a reasonably high probability that an event associated with the web-query and location will be added in the future.

It should also be noted that there are additional and alternative ways to determine that there is no event associated with a web-query. For instance, while the web-query “Britney Spears” may be associated with a number of event categories, such as “Britney Spears Concert” and “Pop Concert”, the web-query “Britney Spears Perfume” may not be associated with an event category. The web-query segment “Perfume” provides non-event context. Non-event context refers to a word, phrase, or other indication that may be analyzed to determine that a web-query is likely not related to an event or seeking event-related information. Such non-event context may be utilized to determine whether to provide event-search results to the user. Similarly, non-event context may be utilized to determine whether to provide an event-alert link to the user.

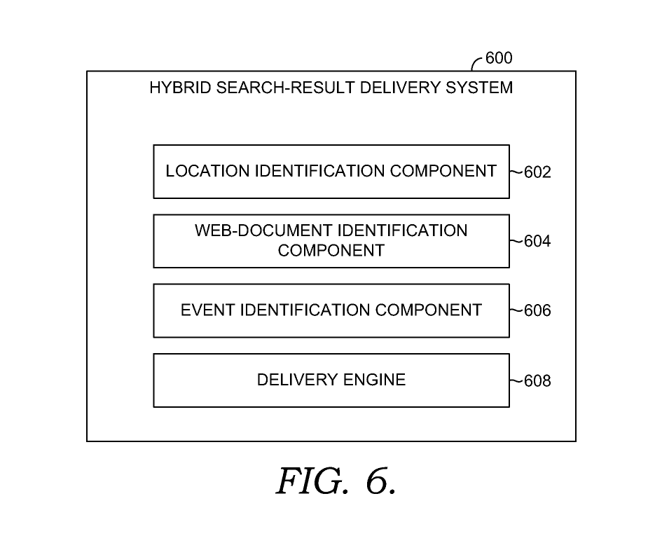

Turning now to FIG. 6, a hybrid search-result delivery system 600 is depicted. The hybrid-search result delivery system 600 includes, among other components not shown, location identification component 602, web-document identification component 604, event identification component 606, and delivery engine 608.

Location identification component 602 generally allows for the identification of a location associated with a user. For example, location identification component 602 may be provided with a user's IP address, which location identification component 602 may analyze to determine a location associated with the user. Alternatively, location identification component 602 may be provided with a user's search history, which location identification component 602 may analyze to determine a location associated with the user. It should be noted that there are numerous ways in which location identification component 602 may function, including the analysis of web-queries, user history, user profiles, GPS coordinates, historical user GPS information, etc.

In one embodiment, a user may connect to a search engine server and provide the IP address of her device. The search engine server may connect to location identification component 602 and transmit this IP address. Location identification component 602 may analyze this IP address to determine that the user is likely on a cellular telephone in Boise, Id. The search engine server may receive a web-query from the user. The search engine server may connect to web-document identification component 604 and transmit the web-query to this component. Web-document identification component 604 may identify one or more web-search results associated with the received web-query. The search engine server may also connect to event identification component 606 and transmit the web-query and the location identified by location identification component 602. Event identification component 606 may identify one or more events associated with the web-query and location to produce one or more event-search results. These event-search results and web-search results may be provided to the user by the delivery engine 608.

In some embodiments, the components of hybrid search-result delivery system 600 may interact with each other dynamically to identify a relevant event. For example, a user may connect to a search engine server via a laptop computer in San Francisco, Calif. The user may submit a web-query “Town Hall” to the search engine server. The search engine server may access a user cookie indicating from where the user commonly accesses the search engine. The search engine server may transmit cookie information and the web-query to the hybrid search-result delivery system 600. This cookie information may be submitted to location identification component 602 of hybrid search-result delivery system. Location identification component 602 may analyze the cookie information to identify “Menlo Park, Calif.” as a location associated with the user. Further, the web-query may be transmitted to web-document identification component 604, which may query a datastore index of a plurality of Internet documents to identify a web-search result associated with a website related to the web-query “Town Hall”. The web-query and identified location may be transmitted to event identification component 606, which may determine that there is no event associated with the web-query “Town Hall” and location of Menlo Park, Calif. This result—that there is no event associated with this web-query and location—may be communicated to location identification component 602, which may then attempt to determine a second location associated with the user.

Location identification component 602 may analyze the cookie information to determine that the location of “San Francisco, Calif.” is also associated with the user. Alternatively, location identification component 602 may request additional information, such as GPS coordinates, to make a determination of a second location associated with the user. The location “San Francisco, Calif.” may be transmitted to event identification component 606. Event identification component 606 may query an event datastore with “San Francisco, Calif.” and the already received web-query “Town Hall” and determine that an event associated with this particular web-query and location is currently underway at the Hilton Hotel in San Francisco. An event-search result associated with this event, along with the identified web-search result, may be provided to the user by delivery engine 608. The user may be presented with an interface resembling 300, with the identified web-search result at 304 and the identified event-search result at 306. The identified web-search result 304 may indicate the specific location (i.e., the address and/or hotel name) of the event, and provide a link to order a ticket or request a taxi.

In some embodiments, multiple event-search results and/or multiple web-search results may be provided to the user. In such embodiments, the web-search results and/or event search-results may be ranked against each other based on relevance to the user. In some embodiments, the event identification component may include a database of non-event contextual cues. In some embodiments, whether to provide hybrid search results may be determined based on analyzing a user preference.

As can be understood, embodiments of the present invention are directed to providing hybrid search results comprising web-search results, event-search results and/or event-alert links. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, cause the one or more computing devices to perform a method comprising:
receiving a web-query from a user;
identifying a location associated with the user;
identifying an event-search result based on the location and the web-query;
identifying a web-search result based on the web-query; and
providing the web-search result and the event-search result for display to the user.

2. The one or more computer-readable media of claim 1, wherein the location is identified based on analyzing one or more of the following: an IP address of the user, the GPS coordinates of the user, a profile associated with the user, and content of the web-query.

3. The one or more computer-readable media of claim 1, wherein the event-search result is identified based on querying an event database.

4. The one or more computer-readable media of claim 3, wherein the event database is populated utilizing an API.

5. The one or more computer-readable media of claim 1, wherein the method further comprises:
receiving an event-alert request from the user; and
creating an event alert associated with the user in response to the event-alert request.

6. The one or more computer-readable media of claim 5, wherein the event alert notifies the user of an event associated with the web-query via email.

7. The one or more computer-readable media of claim 5, wherein the event alert is associated with the location of the user at the time the web-query was received.

8. The one or more computer-readable media of claim 1, wherein the method further comprises determining that the web-query is related to an event category.

9. The one or more computer-readable media of claim 1, wherein the user is provided with an opportunity to purchase a ticket for the event.

10. One or more computer-readable media storing computer-useable instructions that, when used by one or more computing devices, cause the one or more computing devices to perform a method comprising:
receiving a web-query from a user;
identifying a location associated with the user;
determining that there is no event associated with the location and the web-query;
identifying a web-search result based on the web-query; and
providing the web-search result and an event-alert link for display to the user.

11. The one or more computer-readable media of claim 10, wherein the method further comprises determining that the web-query is related to an event.

12. The one or more computer-readable media of claim 11, wherein determining that the web-query is related to an event comprises analyzing the web-query for non-event context.

13. The one or more computer-readable media of claim 10, wherein the method further comprises:
receiving an event-alert request from the user;
storing a token associated with the event-alert request in a database; and
providing an event alert to the user based on querying the database.

14. The one or more computer-readable media of claim 10, wherein determining to provide an event-alert link to the user comprises determining a probability that a future event related to the web-query will be added to the event database.

15. One or more computer-readable media storing computer-useable instructions that, when used by one or more computing devices, cause the one or more computing devices to provide hybrid search-results, the hybrid search-results comprising:
a web-search result, the web-search result being associated with a web page; and
an event-search result, the event-search result being associated with a time and a location.

16. The one or more computer-readable media of claim 15, wherein the event-search result is identified based on querying an event database.

17. The one or more computer-readable media of claim 15, wherein the web-search result and event-search result are identified based on analyzing a web-query received from a user.

18. The one or more computer-readable media of claim 15, wherein it is determined to provide hybrid search-results based on analyzing a web-query received from a user.

19. The one or more computer-readable media of claim 18, wherein analyzing the web-query comprises determining that the web-query does not contain non-event context.

20. The one or more computer-readable media of claim 15, wherein it is determined to provide hybrid search-results based on analyzing a user profile.
